(19) United States
(12) Patent Application Publication
(10) Pub. No.: US 2012/0123857 A1
(43) Pub. Date: May 17, 2012

(54) Bidding Model for Sponsored Search Advertising Based on User Query Intent

(76) Inventors: Mrugank Kiran Surve, Bangalore (IN); Prasannakumar J M, Bangalore (IN)

(21) Appl. No.: 12/944,424

(22) Filed: Nov. 11, 2010

(51) Int. Cl. G06Q 30/00

(52) U.S. Cl. 705/14.49

(57) ABSTRACT

A method and a system are provided for sponsored search ad bidding based on user query intent and matching one or more ads to a user's query intent. In one example, the system receives a bid intent of an advertiser for an ad, a query intent of a user, a click-through rate for the bid intent, and a bid value for the ad. The system generates a proximity value for the ad by calculating a proximity between the bid intent of the advertiser and the query intent of the user. The system generates an effective bid value for the ad by using the click-through rate for the bid intent, the bid value for the ad, and the proximity value for the ad. The system ranks the ad among other ads by using the effective bid value for the ad, wherein the ranking is based on the query intent of the user.

### FIELD OF THE INVENTION

The invention relates to online advertising. More particularly, the invention relates to matching one or more ads to a user's query intent by using a bidding model for sponsored search advertising based on user query intent.

### BACKGROUND

An advertiser, such as Ford™ or McDonald's™, generally contracts a creative agency for ads to be placed in various media for the advertiser's products. Such media may include TV, radio, Internet ads (e.g., sponsored search ads, banner display ads, textual ads, streaming ads, mobile phone ads, etc.) or print medium ads (e.g., ads in newspapers, magazines, posters, etc.). The advertiser may engage one or more creative agencies that specialize in generating ads for one or more of the above media. A company wants to show the most relevant ads to end users in order to get the most value from their ad campaign.

One way to show relevant ads to users is to generate models for sponsored search key-word bidding. The models are configured to match key-word searches conducted by users with appropriate ads for those users. Web search providers (e.g., Yahoo!™, Google™, Bing™) use keyword bidding models to sell sponsored search ad space. Using the models, search advertisers bid for keywords that will potentially be searched by potential customers. The advertisers are essentially guessing the intents of search users based on the keywords in the users' queries. For example, if a search query contains the keyword “car”, then that user is probably looking to buy a car. The search provider should show that user car related ads.

Unfortunately, conventional models for sponsored search keyword-bidding have problems. Search advertisers must continuously bid for new keywords and revise bids of existing keywords that represent their business. Managing bids for a large number of keywords is time-consuming, tedious and sub-optimal. Conversions (e.g., user making a purchase) are less as the sponsored ads are more so matching keywords, and less so matching actual user query intent. Also, search users will not get better ads as the intent is not matched with the ads. Further, search providers (e.g., Yahoo!™, Google™, Bing™) experience a low click-through rates (CTR) on the sponsored search ad. The search provider wastes precious ad space for those keywords which do not receive bids from advertisers, but users may have the intent to buy the product. Lack of bids means lost revenue opportunity for the search provider.

FIG. 1 illustrates problematic results 100 of a conventional model. A first user 112 has a query intent 120 to buy an iPod Nano™. A second user 114 has a query intent 122 to buy a Tata Nano™. A third user 116 has a query intent 124 to buy a nano mouse. The resulting sponsored search ads 108 do not match the query intents. In this example, the mismatching are due to the model being inaccurate.

FIG. 2 illustrates problematic results 200 including larger sponsored search ads 208 for easier viewing purposes. The sponsored search ads 208 do not match the query intents 220, 222 and 224 of the users 212, 214 and 216, respectively.

### SUMMARY

What is needed is an improved method having features for addressing the problems mentioned above and new features not yet discussed. Broadly speaking, the invention fills these needs by providing a method and a system for matching one or more ads to a user's query intent by using a bidding model for sponsored search advertising.

In a first embodiment, a computer-implemented method is provided for matching one or more ads to a user's query intent. The method comprises the following: receiving, at a computer, a bid intent of a messenger for an item, a query intent of a user, a click-through rate for the bid intent, and a bid value for the item; generating, at a computer, a proximity value for the item by calculating a proximity between the bid intent of the messenger and the query intent of the user; generating, at a computer, an effective bid value for the item by using the click-through rate for the bid intent, the bid value for the item, and the proximity value for the item; and ranking, at a computer, the item among other items by using the effective bid value for the item, wherein the ranking is based on the query intent of the user.

In a second embodiment, a system is provided for matching one or more ads to a user's query intent. The system comprises a computer system configured for the following: receiving a bid intent of a messenger for an item, a query intent of a user, a click-through rate for the bid intent, and a bid value for the item; generating a proximity value for the item by calculating a proximity between the bid intent of the messenger and the query intent of the user; generating an effective bid value for the item by using the click-through rate for the bid intent, the bid value for the item, and the proximity value for the item; and ranking the item among other items by using the effective bid value for the item, wherein the ranking is based on the query intent of the user.

In a third embodiment, a computer readable medium is provided comprising one or more instructions for matching one or more ads to a user's query intent. The one or more instructions are configured for causing one or more processors to perform at least the following steps: receiving a bid intent of a messenger for an item, a query intent of a user, a click-through rate for the bid intent, and a bid value for the item; generating a proximity value for the item by calculating a proximity between the bid intent of the messenger and the query intent of the user; generating an effective bid value for the item by using the click-through rate for the bid intent, the bid value for the item, and the proximity value for the item; and ranking the item among other items by using the effective bid value for the item, wherein the ranking is based on the query intent of the user.

The invention encompasses other embodiments configured as set forth above and with other features and alternatives. It should be appreciated that the invention may be implemented in numerous ways, including as a method, a process, an apparatus, a system or a device.

### BRIEF DESCRIPTION OF THE DRAWINGS

The invention will be readily understood by the following detailed description in conjunction with the accompanying drawings. To facilitate this description, like reference numerals designate like structural elements.

FIG. 1 illustrates problematic results 100 of a conventional model;

FIG. 2 illustrates problematic results 200 including larger sponsored search ads 208 for easier viewing purposes;

FIG. 3 is a high-level block diagram of a system 300 for matching user query intent, in accordance with some embodiments;

FIG. 4 illustrates results 400 of the system for matching query intent, in accordance with some embodiments;

FIG. 5 illustrates results 500 including larger sponsored search ads 504, 506 and 508 for easier viewing purposes;

FIG. 6 illustrates the factors 600 involved for associating bid intent with a particular ad, in accordance with some embodiments;

FIG. 7 shows example relationships 700 between different intent granularities, in accordance with some embodiments;

FIG. 8 is an intent hierarchy 800, in accordance with some embodiments. The intent hierarchy 800 is just a snapshot;

FIG. 9 intent hierarchy 900 that illustrates the levels of the hierarchy, in accordance with some embodiments;

FIG. 10 is a flowchart of a method 1000 for ranking sponsored ads by using a bidding model, in accordance with some embodiments; and

FIG. 11 is a diagrammatic representation of a network, including nodes that may comprise a machine within which a set of instructions may be executed, in accordance with some embodiments.

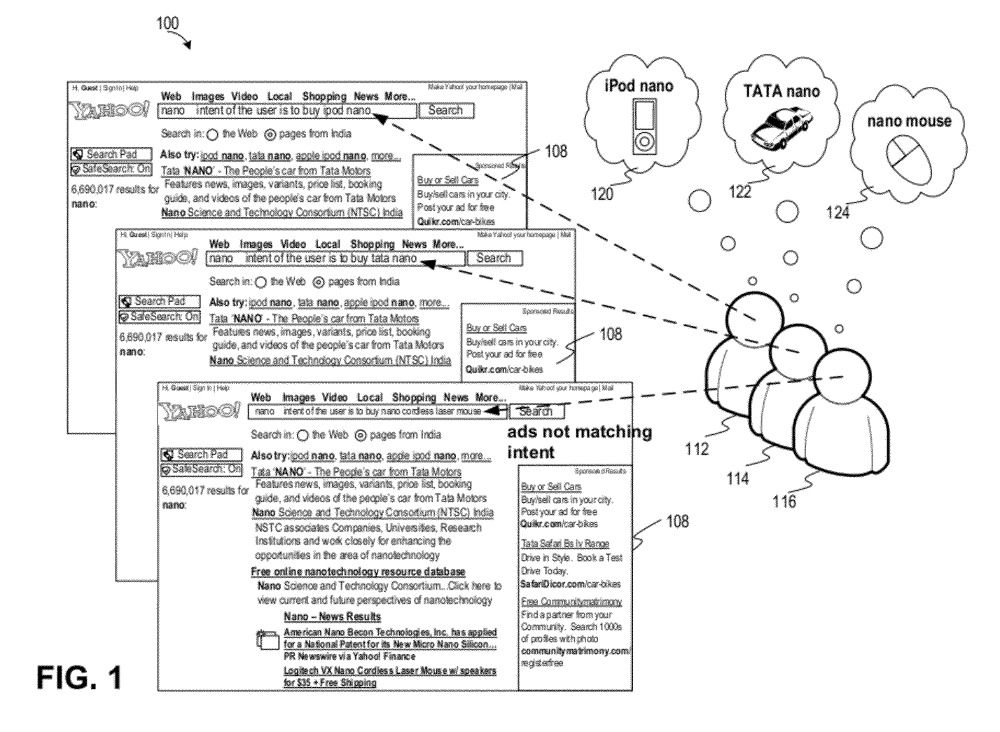

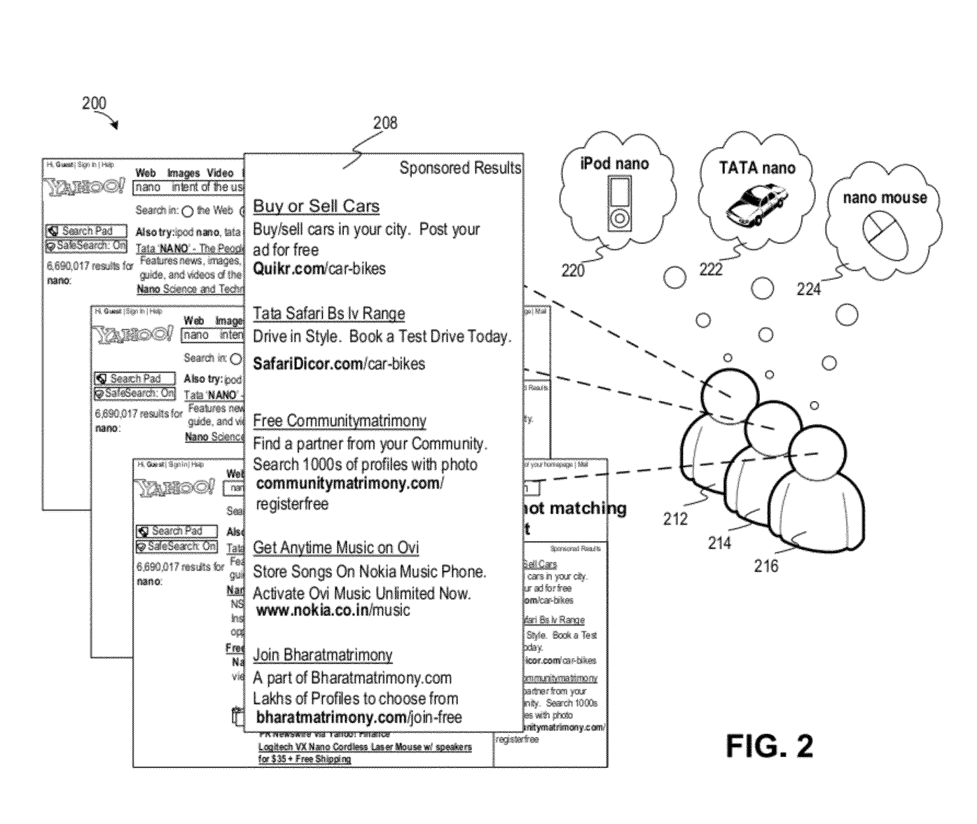

### DETAILED DESCRIPTION

An invention is disclosed for a method and a system for a bidding model for sponsored search advertising based on a user's query intent. Numerous specific details are set forth in order to provide a thorough understanding of the invention. It will be understood, however, to one skilled in the art, that the invention may be practiced with other specific details.

### DEFINITIONS

Some terms are defined below in alphabetical order for easy reference. These terms are not rigidly restricted to these definitions. A term may be further defined by the term's use in other sections of this description.

“Ad” (e.g., ad, item and/or message) means a paid announcement, as of goods or services for sale, preferably on a network, such as the Internet. An ad may also be referred to as an ad, an item and/or a message.

“Ad server” is a server that is configured for serving one or more ads to user devices. An ad server is preferably controlled by a publisher of a Web site and/or an advertiser of online ads. A server is defined below.

“Advertiser” (e.g., messenger and/or messaging customer, etc.) means an entity that is in the business of marketing a product and/or a service to users. An advertiser may include without limitation a seller and/or a third-party agent for the seller. An advertiser may also be referred to as a messenger and/or a messaging customer. Advertising may also be referred to as messaging.

“Advertising” means marketing a product and/or service to one or more potential consumers by using an ad. One example of advertising is publishing a sponsored search ad on a Web site.

“Application server” is a server that is configured for running one or more devices loaded on the application server. For example, an application server may run a device configured for deducing shadow profiles.

“Bid intent” means an advertiser's parameters for the targeting of an ad. Bid intent is defined in terms of possible query intent. For example, an advertiser of Ford Equinox may have the following bid intent: “Show my ads to users who have a query intent to buy Ford Equinox, $22000-$25000.”

“Click” (e.g., ad click) means a selection of an ad impression by using a selection device, such as, for example, a computer mouse or a touch-sensitive display.

“Click-through rate”, also known as CTR or ad click-though rate, means a measurement of how many times users click on an ad per unit view. CTR preferably equals ad clicks per ad views.

“Client” means the client part of a client-server architecture. A client is typically a user device and/or an application that runs on a user device. A client typically relies on a server to perform some operations. For example, an email client is an application that enables a user to send and receive e-mail via an email server. The computer running such an email client may also be referred to as a client.

“Database” (e.g., database system, etc.) means a collection of data organized in such a way that a computer program may quickly select desired pieces of the data. A database is an electronic filing system. In some instances, the term “database” is used as shorthand for “database management system”. A database may be implemented as any type of data storage structure capable of providing for the retrieval and storage of a variety of data types. For instance, a database may comprise one or more accessible memory structures such as a CD-ROM, tape, digital storage library, flash drive, floppy disk, optical disk, magnetic-optical disk, erasable programmable read-only memory (EPROM), random access memory (RAM), magnetic or optical cards, etc.

“Device” means hardware, software or a combination thereof. A device may sometimes be referred to as an apparatus. Examples of a device include without limitation a software application such as Microsoft Word™, a laptop computer, a database, a server, a display, a computer mouse and/or a hard disk.

“Item” means an ad, which is defined above.

“Marketplace” means a world of commercial activity where products and/or services are browsed, bought and/or sold, etc. A marketplace may be located over a network, such as the Internet. A marketplace may also be located in a physical environment, such as a shopping mall.

“Message” means an ad, which is defined above.

“Messaging” means advertising, which is defined above.

“Messenger” means an advertiser, which is defined above.

“Network” means a connection, between any two or more computers, that permits the transmission of data. A network may be any combination of networks, including without limitation the Internet, a local area network, a wide area network, a wireless network and a cellular network.

“Publisher” means an entity that publishes, on a network, a Web page having content and/or ads, etc.

“Query intent” means what a user actually wants when the user initiates a search at a website, such as a web portal (e.g. Yahoo!™, Google™). Query intent is not bound by a fixed set of keywords and/or search terms. Query intent algorithms exist that are specifically designed to infer a user's query intent by using the user's search terms and other statistics. Accordingly, query intent is a best guess of what the user actually wants.

“Server” means a software application that provides services to other computer programs (and their users), in the same computer or another computer. A server may also refer to the physical computer that has been set aside to run a specific server application. For example, when the software Apache HTTP Server is used as the Web server for a company's Web site, the computer running Apache may also be called the Web server. Server applications may be divided among server computers over an extreme range, depending upon the workload.

“Software” means a computer program that is written in a programming language that may be used by one of ordinary skill in the art. The programming language chosen should be compatible with the computer by which the software application is to be executed and, in particular, with the operating system of that computer. Examples of suitable programming languages include without limitation Object Pascal, C, C++ and Java. Further, the functions of some embodiments, when described as a series of steps for a method, could be implemented as a series of software instructions for being operated by a processor, such that the embodiments could be implemented as software, hardware, or a combination thereof. Computer readable media are discussed in more detail in a separate section below.

“System” means a device or multiple coupled devices. A device is defined above.

“User” (e.g., consumer, etc.) means an operator of a user device. A user is typically a person who seeks to acquire a product and/or service. For example, a user may be a woman who is browsing Yahoo!™ Shopping for a new cell phone to replace her current cell phone. The term “user” may refer to a user device, depending on the context.

“User device” (e.g., computer, user computer, client and/or server, etc.) means a single computer or to a network of interacting computers. A user device is a computer that a user may use to communicate with other devices over a network, such as the Internet. A user device is a combination of a hardware system, a software operating system and perhaps one or more software application programs. Examples of a user device include without limitation a laptop computer, a palmtop computer, a smart phone, a cell phone, a mobile phone, an IBM-type personal computer (PC) having an operating system such as Microsoft Windows™, an Apple™ computer having an operating system such as MAC-OS, hardware having a JAVA-OS operating system, and a Sun Microsystems Workstation having a UNIX operating system.

“Web browser” means a software program that may display text, graphics, or both, from Web pages on Web sites. Examples of a Web browser include without limitation Mozilla Firefox™ and Microsoft Internet Explorer™.

“Web page” means documents written in a mark-up language including without limitation HTML (hypertext mark-up language), VRML (virtual reality modeling language), dynamic HTML, XML (extended mark-up language) and/or other related computer languages. A Web page may also refer to a collection of such documents reachable through one specific Internet address and/or through one specific Web site. A Web page may also refer to any document obtainable through a particular URL (Uniform Resource Locator).

“Web portal” (e.g., public portal) means a Web site or service that offers a broad array of resources and services, such as, for example, e-mail, forums, search engines, and online shopping malls. The first Web portals were online services, such as AOL, that provided access to the Web. However, now, most of the traditional search engines (e.g., Yahoo!™) have transformed themselves into Web portals to attract and keep a larger audience.

“Web server” is a server configured for serving at least one Web page to a Web browser. An example of a Web server is a Yahoo!™ Web server. A server is defined above.

“Web site” means one or more Web pages. A Web site preferably includes plurality of Web pages, virtually connected to form a coherent group.

### Architecture Overview

As stated above, conventional models for sponsored search keyword-bidding have problems. The description below provides a system configured for solving the drawbacks of conventional models.

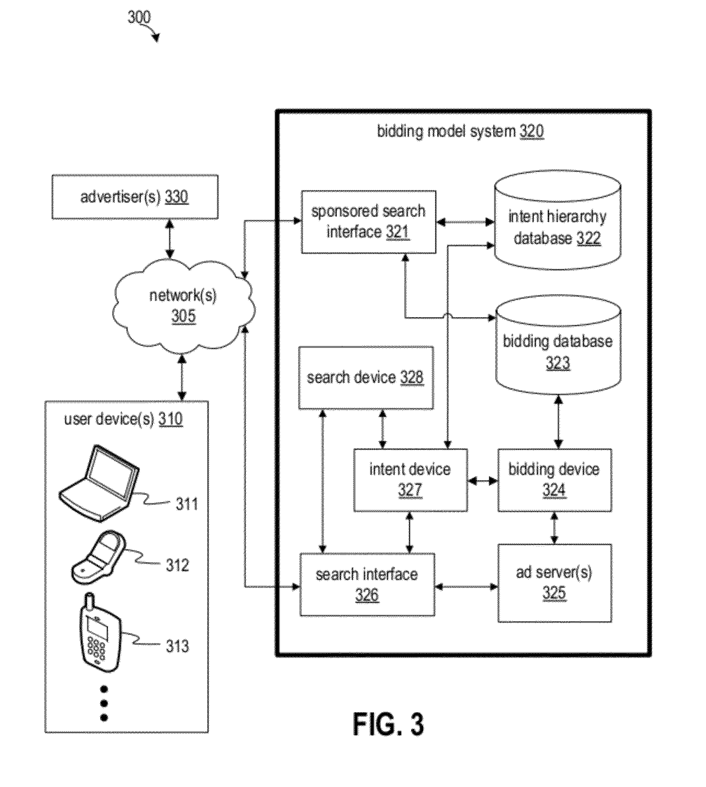

FIG. 3 is a high-level block diagram of a system 300 for matching user query intent, in accordance with some embodiments. The system is configured using a bidding model for search advertising. The one or more networks 305 couple together a bidding model system 320, one or more user devices 310, and one or more advertisers 330. The network 305 may be any combination of networks, including without limitation the Internet, a local area network, a wide area network, a wireless network and/or a cellular network.

Each user device 310 includes without limitation a single computer or a network of interacting computers. Examples of a user device include without limitation a laptop computer 311, a cell phone 312 and a smart phone 313. A user may communicate with other devices over the network 305 by using a user device 310. A user may be, for example, a person browsing or shopping in a marketplace on the Internet.

The bidding model system 320 performs important operations of the system 300 and is described further below in other sections. The bidding model system 320 may operated by a company like Yahoo!™. The bidding model system 320 in the example of FIG. 3 includes without limitation the following: a sponsored search interface 321, a search interface 326, a search device 328, an intent device 327, a bidding device 324, one or more ad servers 325, an intent hierarchy database 322, and a bidding database 323. The sponsored search interface 321 is coupled to the network 305, the intent hierarchy database 322, and the bidding database. The search interface 326 is couple to the network 305, the search device 328, the intent device 327, and the ad server 325. The search device is also couple to the intent device 327. The intent device is also coupled to the bidding device and the intent hierarchy database 322. The bidding device is also coupled to the ad server 325 and the bidding database 323.

The bidding device 324 carries out the more important operations of the system 300. For example, the output of the bidding device 324 is the effective bid value for an ad, which is depicted by Equation 2 below.

The bidding model system 320 is configured with programs, algorithms, applications, software, graphical user interfaces, models, other tools and/or other procedures necessary to implement and/or facilitate methods and systems according to embodiments of the invention, or computerized aspects thereof, whether on one computer or distributed among multiple computers or devices. These include local and global adjustment, decision making, or optimizations, weighting, pricing, allocation, scheduling, serving, and/or other techniques. In various embodiments, the elements of the bidding model system 320 may exist on one computer, or may exist on multiple computers, devices and/or locations.

The ad server 325 may be directly incorporated in the bidding model system 320, remotely coupled to the bidding model system 320 via the one or more networks 305, and/or controlled by a separate entity (e.g., a third party ad network). The ad servers 325 are configured for serving one or more ads to the user devices 310. An advertiser 330 is an entity that is seeking to market a product and/or a service to users at the user devices 310. Examples of an advertiser 330 include without limitation Amazon.com™, Nike™ and Yahoo!™.

The bidding model system 320 is configured for communicating with one or more advertisers 330. The bidding model 320 is further configured for communicating with the one or more user devices 310 and for serving at least one Web page to a Web browser on a user device 310.

The configuration of the system 300 in FIG. 3 is for explanatory purposes. For example, in some embodiments, the ad servers 325 may be part of an ad exchange. For example, some Web portals operate, utilize, or facilitate advertising exchanges. Such exchanges may virtually connect parties including advertisers, publishers, networks of advertisers, networks of publishers, and other entities. The exchange may facilitate arrangements, bidding, auctioning in connection with ads and ad campaigns, and may also facilitate planning and serving of ads. Ads that may be included within the exchange may include display or graphical ads that are served in connection with user searches including keyword-based searches. The exchange may also include sponsored search ads, including ads served in association with user searches, such as keyword searches. Any type of simple or sophisticated ads may be included, such as text, graphic, picture, video and audio ads, streaming ads, interactive ads, rich media ads, etc.

In some embodiments, active ads are ads that are available for serving on or in connection with the exchange, whereas non-active ads are not so available. For example, non-active ads may include ads that are in review prior to be available for serving. This may include review as part of an editorial process to try to ensure or reduce the chance that inappropriate or dangerous ads are not allowed to be active. There are numerous other configurations in other embodiments that are possible.

### Matching Query Intent

The system is configured for using a model that helps advertisers search and bid on user query intent, instead of keywords. Query intent does not bind to a fixed set of keywords. Query intent is theoretically what a user wants when the user initiates a search. The system makes bidding independent of the set of keywords that may otherwise be used for bidding.

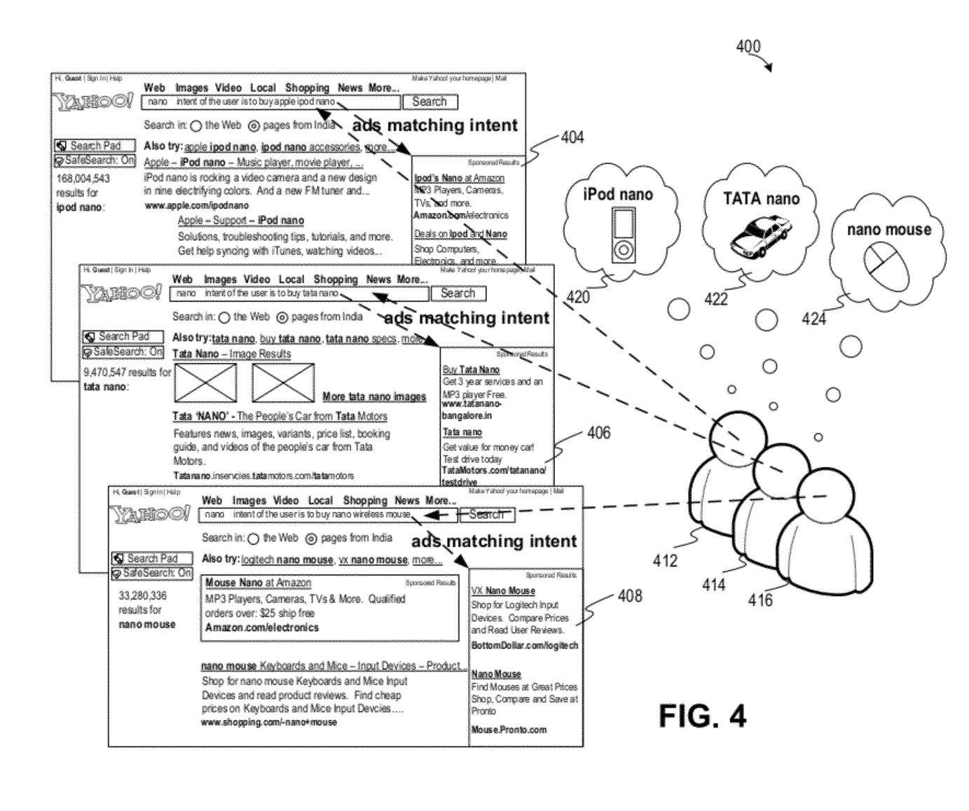

FIG. 4 illustrates results 400 of the system for matching query intent, in accordance with some embodiments. A first user 412 has a query intent 420 to buy an iPod Nano™. A second user 414 has a query intent 422 to buy a Tata Nano™. A third user 416 has a query intent 424 to buy a nano mouse. The resulting sponsored search ads 404, 406 and 408 match the query intents 420, 422 and 424, respectively. The matching is due to system having an accurate bidding model for sponsored search advertising.

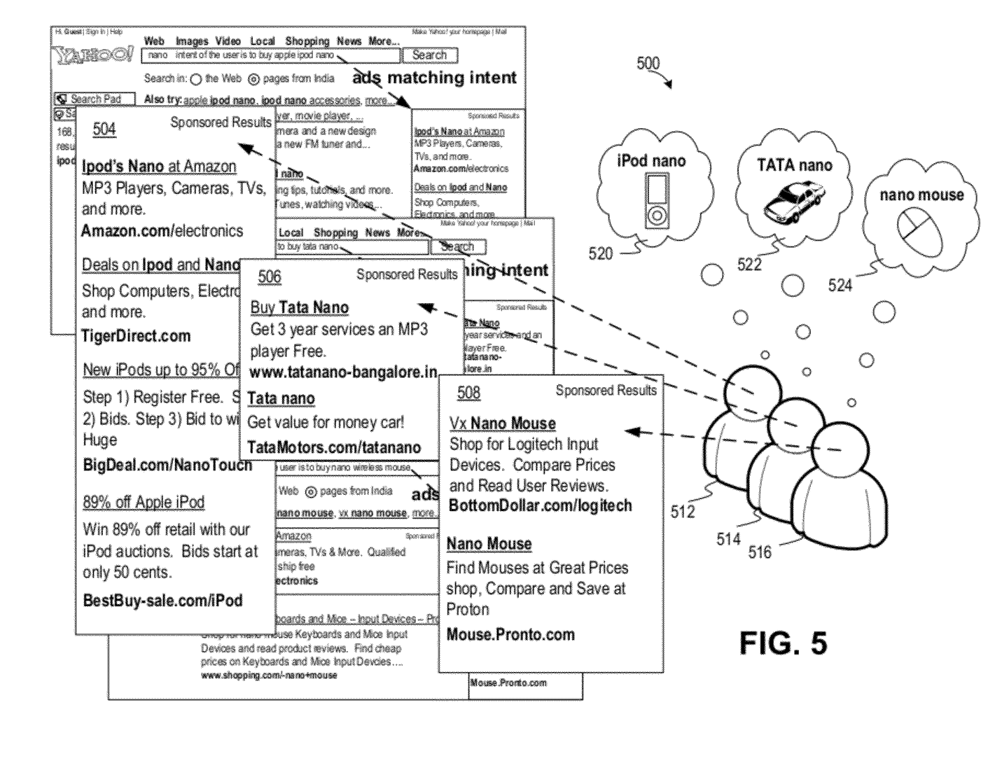

FIG. 5 illustrates results 500 including larger sponsored search ads 504, 506 and 508 for easier viewing purposes. The sponsored search ads 504, 506 and 508 match the query intents 520, 522 and 524 of the users 512, 514 and 516, respectively.

Given a bidding model, an advertiser may bid for query intents relevant to the advertiser's business. Such a bid may be referred to as a bid intent. Bid intent is an advertiser's parameters for the targeting of an ad. Consider, for example, an advertiser that is an Equinox dealer in CA. An advertiser may issue the following bid intent, “Show my ads to users with the following query intent: users with query intent to buy Equinox with budget $22000-$25000 from CA”. The system is configured for providing a model that will allow the advertiser's bid to be accurately accommodated.

FIG. 6 illustrates the factors 600 involved for associating an advertiser's bid intent with a particular ad, in accordance with some embodiments. Each ad is associated with a bid value, a bid intent and an ad click-through rate (CTR) for the bid intent. In comparison, each user query is associated with a calculated query intent. Query intent is what a user actually wants when the user initiates a search at a website, such as a web portal (e.g. Yahoo!™, Google™).

The system is configured for matching ads by using the following proximity function:

proximity_value=proximity(advertiser's bid intent, user's query intent)

### Equation 1. Proximity Value

Equation 1 quantifies the closeness (match level) between a user's query intent and a bid intent. In Equation 1, 0<=proximity_value<=1. A proximity_value of 1 represents an exact match between the bid intent and the user's query intent. A proximity_value of 0 represents no correlation between the bid intent and the user's query intent. Equation 1 means a proximity value is a function of an advertiser's bid intent and a user's query intent. The proximity_value may be calculated by the bidding device 324 of FIG. 3.

Ads are ranked based on the maximization of the following objective function:

effective_bid_value=function(CTR for bid intent, bid value, proximity_value)

### Equation 2. Effective Bid Value

Equation 2 means the effective bid value of an ad is a function of the CTR for that ad for a particular bid intent, bid value, and proximity value. The CTR of an ad for a bid intent may be calculated by the intent device 327 of FIG. 3. The effective bid value is the effective value of the ad for the advertiser associated with the ad.

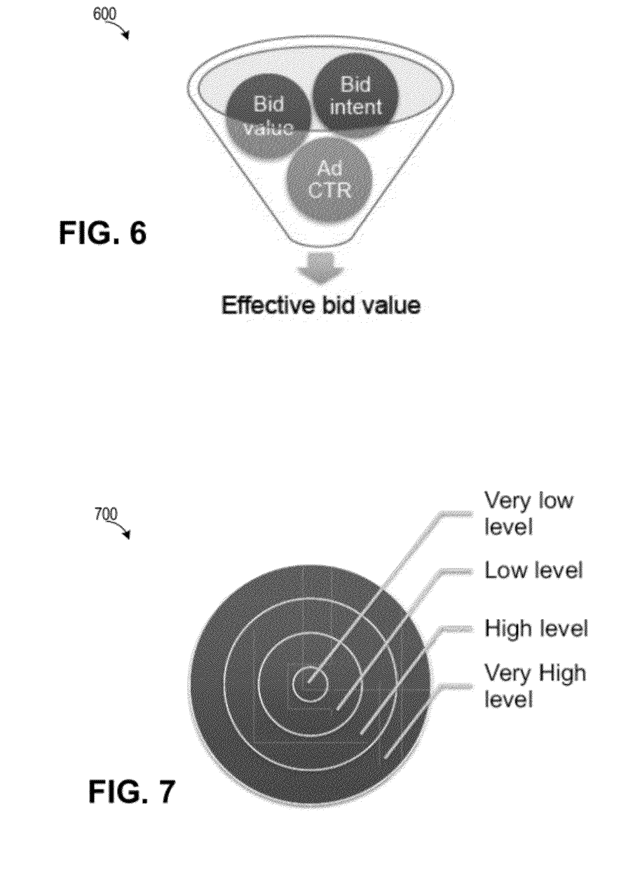

FIG. 7 shows example relationships 700 between different intent granularities, in accordance with some embodiments. An advertiser may choose the level of intent (e.g., granularity of high level intent to granularity of low level intent) based on the advertiser's needs. The definition of query intent spans from general intent (e.g., very high level intent) to specific intent (e.g., very low level intent). Intent granularity is directly proportional to the number users. In the example of FIG. 7, users with “low level intent” are subsets of users with “very high level intent”.

An example of a very high level intent is the following: “user with intent to buy a car”. An example of a high level intent is the following: “user with intent to buy an SUV, with a budget range of $20,000”. An example of a low level intent is the following: “user from California, with intent to buy an SUV, with a budget range of $20,000-$25,000”. An example of a very low level intent is the following: “user from California, within age bracket 40-50 years old, with intent to buy a Ford Equinox™”.

### Intent Hierarchy

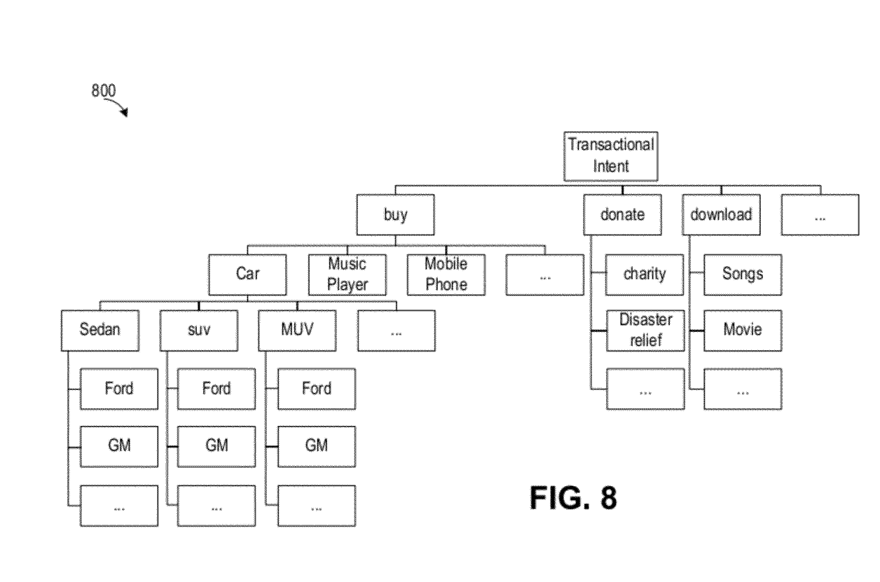

FIG. 8 is an intent hierarchy 800, in accordance with some embodiments. The intent hierarchy 800 is just a snapshot. A working hierarchy will likely be several orders of magnitude larger and will be intended to capture substantially most of the possible intents. The system preferably considers transactional intent, which makes sense for sponsored ads. Transactional intent is a user's intent to purchase a product and/or service.

The intent hierarchy 800 is a N-ary tree structure that describes the hierarchical organization of intents. From a mathematical point of view, a function of N arguments can always be considered as a function of one single argument which is an element of some product space. However, it may be convenient for notation to consider N-ary functions.

When a user interacts with the system with transactional intent, the intent falls into one of the nodes in the intent hierarchy 800. For example, if a user has intent “I want to buy a Ford™ SUV”, the user's intent falls into the following node of the intent hierarchy 800 of FIG. 8:

TABLE 1
Example Node for Classifying a User's Intent

User's Intent Node = Transactional_Intent→Buy→Car→SUV→Ford ™

The advertiser bids for an intent in the intent hierarchy 800 based on the advertiser's business requirement. For example, if an advertiser is a Ford™ dealer, the advertiser may bid for one of the following nodes in the intent hierarchy 800 of FIG. 8:

TABLE 2
Example Nodes upon which an Advertiser Bids

Advertiser's Intent Node = Transactional
Intent →Buy→Car→SUV→Ford ™
Advertiser's Intent Node = Transactional Intent →Buy→Car→SUV

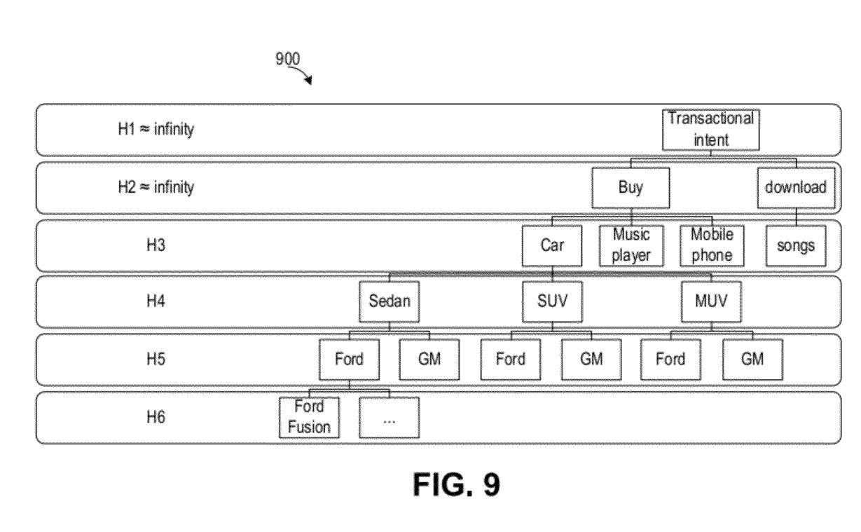

FIG. 9 intent hierarchy 900 that illustrates the levels of the hierarchy, in accordance with some embodiments. Each level in an intent hierarchy is associated with a weight. In the intent hierarchy 900 of FIG. 9, H1 is the weight for the first level (e.g., root). H2 is the weight for the second level. H3 is the weight for the third level. H4 is the weight for the fourth level. H5 is the weight for the fifth level. H6 is the weight for the sixth level, and so on. In mathematical terms, the relationships in the intent hierarchy 900 may be expressed as the following:

H1>>H2>>H3>H4>H5>H6 . . .

### Equation 3. Example Node Relationships in Intent Hierarchy

Let X be the node, in the intent hierarchy, representing the user's query intent. Let Y be the node, in the intent hierarchy, representing the advertiser's bid intent. Let Z be the lowest common ancestor of X and Y. Lowest common ancestor is a concept in graph theory and computer science. Let H(X), H(Y) and H(Z) be the values of constant at node X, Y and Z, respectively. Then, in one example, the proximity value P of an ad is expressed by the following equation:

$$\begin{matrix}Example Proximity Value of an Ad & \\ P = \frac{H ( X ) + H ( Y )}{2 \times H ( Z )} . & Equation 4\end{matrix}$$

Equation 4 is just one example of a proximity value equation. The system is configured for using other proximity value equations as well.

### Proximity Value Illustration

Consider, for example, the following user's intent node in the intent hierarchy 900 of FIG. 9:

TABLE 3
Example User's Intent Node

User's Intent Node = Buy→Car→Sedan→Ford ™

Examples of an advertiser's bid intent nodes in the intent hierarchy 900 of FIG. 9 include the following:

TABLE 4
Example Advertiser Nodes

Advertiser 1 Intent Node = Buy→Car→Sedan→Ford ™
Advertiser 2 Intent Node = Buy→Car→Sedan→
Advertiser 3 Intent Node = Buy→MusicPlayer
Advertiser 4 Intent Node = Buy→MobilePhone
Advertiser 5 Intent Node = Buy→Car
Advertiser 6 Intent Node = Buy→Car→SUV
Advertiser 7 Intent Node = Buy→Car→Sedan→Ford ™→Fusion

Example proximity values for the nodes of Table 3 and Table 4 include the following:

TABLE 5
Example Proximity Values

Ad 1 Proximity Value = (H5 + H5)/(2 × H5)
Ad 2 Proximity Value = (H5 + H4)/(2 × H4)
Ad 3 Proximity Value = (H5 + H5)/(2 × H2)
Ad 4 Proximity Value = (H5 + H4)/(2 × H2)
Ad 5 Proximity Value = (H5 + H3)/(2 × H3)
Ad 6 Proximity Value = (H5 + H4)/(2 × H3)
Ad 7 Proximity Value = (H5 + H6)/(2 × H5)

In Table 5, each proximity value is calculated by using Equation 4 provided above. Next, consider the following sample values for the node levels in the intent hierarchy 900 of FIG. 9:

TABLE 6
Example Values for Intent Levels

H1 = ∞
H2 = ∞
H3 = 16
H4 = 8
H5 = 4
H6 = 2

The proximity values, given Tables 5 and Table 6, would include the following:

TABLE 7
Example Proximity Values

Ad 1 Proximity 1 = 1
Ad 2 Proximity 2 = 0.75
Ad 3 Proximity 3 ≈ 0
Ad 4 Proximity 4 ≈ 0
Ad 5 Proximity 5 = 0.625
Ad 6 Proximity 6 = 0.375
Ad 7 Proximity 7 = 0.75

The system is configured for ranking the ads (or advertisers) according to their proximity values. For example, the ads having proximity values of Table 7 may be ranked as follows:

TABLE 8
Example Ranking of Ads

Ad 1 > Ad 2 or 7 > Ad 7 or 2 > Ad 5 > Ad 6 > Ad 3 or 4 > Ad 4 or 3

Table 8 illustrates how ads are ranked according to bid intent proximity to the user's intent. In this example, the user's intent is provided in Table 3 above. Each advertiser's bid intent is provided in Table 4 above. The ranking of the ads is an aspect of the model that allows a search provider (e.g., Yahoo!™) to send an ad that is most likely to be appropriate to the user device associated with the query intent. In this example, the particular user device is associated with the user's intent of Table 3 above.

This system is not necessarily configured for finding the intent of the user when the user makes query. Finding the intent of the user is a different problem that may be solved by various search engine algorithms. Query intent algorithms exist that are specifically designed to infer query intent of a user. Referring to FIG. 3, the intent device 327 may be configured for calculating query intent.

However, the present system is not directed toward solving the problem of finding exactly what a user's query intent is. As described above with reference to the figures, the present system is directed toward using query intent and other parameters to generate a bidding model for sponsored search ads. The system uses an intent prediction model for bidding to improve the relevancy of ads for users, for better monetization for search providers, and for better targeting and/or reaching services for advertisers.

Overview of Method for Ranking Sponsored Ads by using a Bidding Model

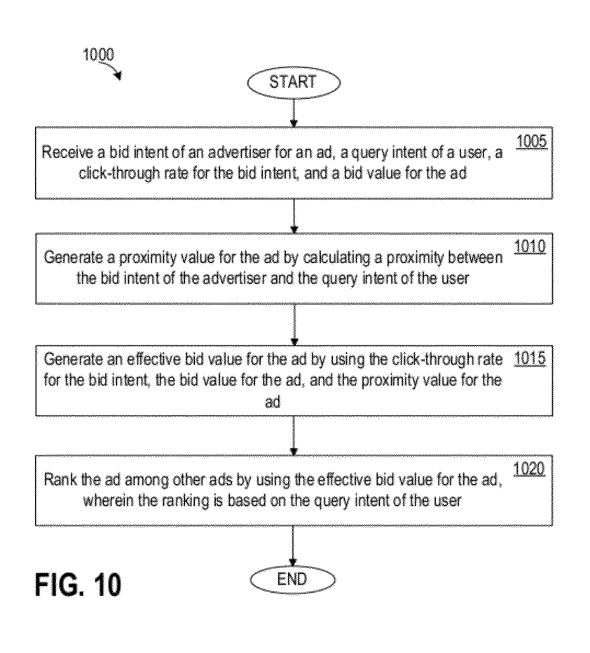

FIG. 10 is a flowchart of a method 1000 for ranking sponsored ads by using a bidding model, in accordance with some embodiments. The steps of the method 1000 may be carried out by one or more devices of the system 300 shown in FIG. 3.

The method 1000 starts in a step 1005 where the system receives a bid intent of an advertiser for an ad, a query intent of a user, a click-through rate for the bid intent, and a bid value for the ad. For example, the bidding device 324 of FIG. 3 may receive from the intent engine 327 the bid intent, the query intent and the click-through rate (CTR). The bidding device 324 of FIG. 3 may receive the bid value from the bidding database 323, which in turn may receive the bid value from the advertiser 330.

The method 1000 proceeds to a step 1010 where the system generates a proximity value for the ad by calculating the proximity between the advertiser's bid intent and the query intent of the user. For example, the bidding device 324 of FIG. 3 may perform this calculation by using Equation 4 above.

Next, in a step 1015, the system generates an effective bid value for the ad by using the click-through rate for the ad for the bid intent, the bid value for the ad, and the proximity value for the ad. For example, the bidding device 324 of FIG. 3 may generate an effective bid value according to Equation 2 above.

The method 1000 then moves to a step 1020 where the system ranks the ad among other ads by using the effective bid value for the ad. The ranking is based on the particular query intent of the user. For example, the bidding device 324 of FIG. 3 may rank the ads. The method 1000 then concludes.

Note that the method 1000 may include other details and steps that are not discussed in this method overview. Other details and steps are discussed with reference to the appropriate figures and may be a part of the method 1000, depending on the embodiment.

### Exemplary Network, Client, Server and Computer Environments

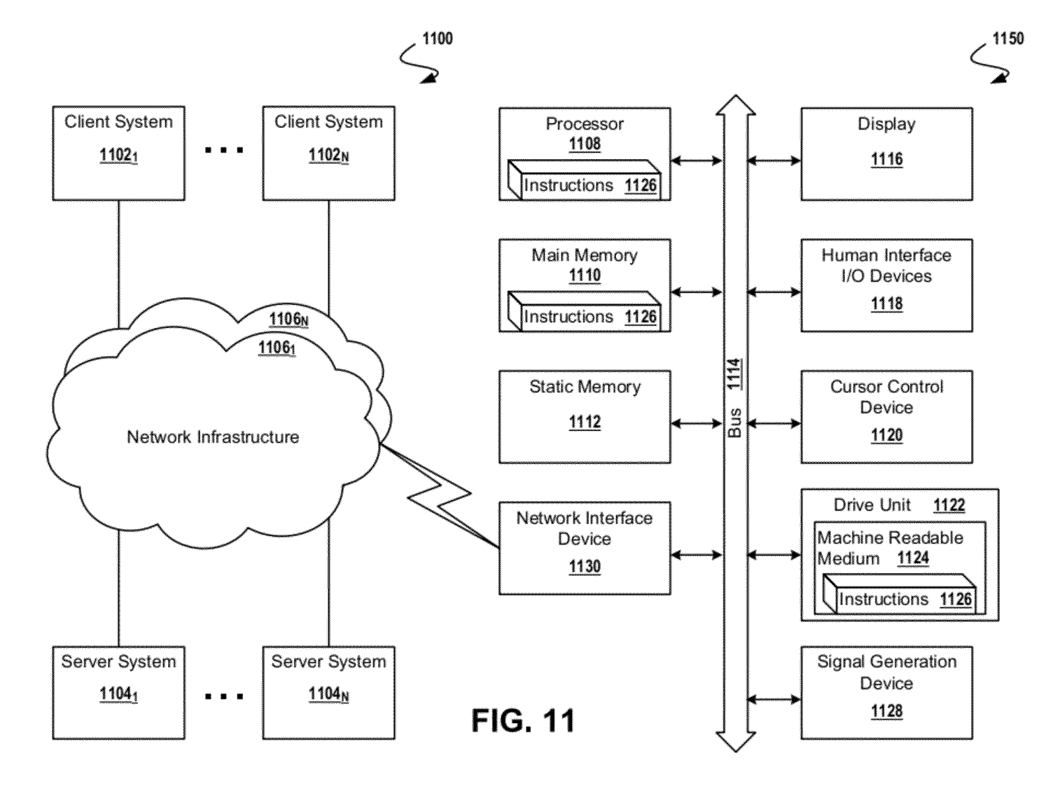

FIG. 11 is a diagrammatic representation of a network 1100, including nodes for client systems 1102₁ through 1102_{N}, nodes for server systems 1104₁ through 1104_{N}, nodes for network infrastructure 1106₁ through 1106_{N}, any of which nodes may comprise a machine 1150 within which a set of instructions, for causing the machine to perform any one of the techniques discussed above, may be executed. The embodiment shown is exemplary, and may be implemented in the context of one or more of the Figures herein.

Any node of the network 1100 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a Web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g., a client computer system, a server computer system) and/or may comprise one or more embedded computer systems, a massively parallel computer system, and/or a cloud computer system.

The computer system 1150 includes a processor 1108 (e.g., a processor core, a microprocessor, a computing device, etc.), a main memory 1110 and a static memory 1112, which communicate with each other via a bus 1114. The machine 1150 may further include a display unit 1116 that may comprise a touch-screen, or a liquid crystal display (LCD), or a light emitting diode (LED) display, or a cathode ray tube (CRT). As shown, the computer system 1150 also includes a human input/output (I/O) device 1118 (e.g. a keyboard, an alphanumeric keypad, etc), a pointing device 1120 (e.g., a mouse, a touch screen, etc), a drive unit 1122 (e.g., a disk drive unit, a CD/DVD drive, a tangible computer readable removable media drive, an SSD storage device, etc.), a signal generation device 1128 (e.g., a speaker, an audio output, etc.), and a network interface device 1130 (e.g., an Ethernet interface, a wired network interface, a wireless network interface, a propagated signal interface, etc.).

The drive unit 1122 includes a machine-readable medium 1124 on which is stored a set of instructions 1126 (e.g., software, firmware, middleware, etc.) embodying any one, or all, of the methodologies described above. The set of instructions 1126 is also shown to reside, completely or at least partially, within the main memory 1110 and/or within the processor 1108. The set of instructions 1126 may further be transmitted or received via the network interface device 1130 over the network bus 1114.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing or transmitting information in a form readable by a machine (e.g., a computer). For example, a machine-readable medium includes read-only memory (ROM); random access memory (RAM); magnetic disk storage media; optical storage media; flash memory devices; electrical, optical or acoustical or any other type of media suitable for storing information.

### Advantages

Embodiments of the system are configured for a bidding model for sponsored search advertising based on user query intent. Search advertisers are relieved from the burden of managing keywords and bids for the keywords. The system allows advertisers to bid on the intent relevant to their business. Accordingly, the system provides better return on investment (ROI) for advertisers.

Search users get relevant ads that match their intent. This ad matching provides for a significantly better user experience.

Search providers (e.g., Yahoo!™, Google™, Bing™) benefit from an increase in CTR due to improved ad relevancy, better search deliveries leading to a satisfied user base, reduced “ad blindness” due to ads that may not be relevant to user intent, and more efficient usage of sponsored ad space, which would have otherwise gone to waste due to keywords not receiving a bid.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A computer-implemented method for sponsored search item bidding based on a user's query intent, the method comprising:
receiving, at a computer, a bid intent of a messenger for an item, a query intent of a user, a click-through rate for the bid intent, and a bid value for the item, wherein the bid intent comprises the messenger's parameters for targeting the item, and wherein the query intent comprises an expression of what the user actually wants when the user initiates a search at a website;
generating, at a computer, a proximity value for the item by calculating a proximity between the bid intent of the messenger and the query intent of the user;
generating, at a computer, an effective bid value for the item by using the click-through rate for the bid intent, the bid value for the item, and the proximity value for the item; and
ranking, at a computer, the item among other items by using the effective bid value for the item, wherein the ranking is based on the query intent of the user.

2. The method of claim 1, further comprising generating, at a computer, an intent hierarchy including intent nodes and hierarchy levels for the intent nodes.

3. The method of claim 2, wherein each hierarchy level in the intent hierarchy is associated with a granularity level that includes at least one of:
very high level intent;
high level intent;
low level intent; and
very low level intent.

4. The method of claim 2, further comprising at least one of:
classifying, at a computer, the bid intent in the intent hierarchy; and
classifying, at a computer, the query intent in the intent hierarchy.

5. The method of claim 2, wherein the proximity value is calculated by using at least one of:
a first node in the intent hierarchy, wherein the first node represents the bid intent;
a second node in the intent hierarchy, wherein the second node represents the query intent; and
the lowest common ancestor of first node and the second node.

6. The method of claim 5, wherein the proximity value is denoted by the following equation:
$$P = \frac{H ( X ) + H ( Y )}{2 \times H ( Z )}$$
wherein X is the node in the intent hierarchy representing the query intent, and
wherein Y is the node in the intent hierarchy representing the bid intent, and
wherein Z be the lowest common ancestor of X and Y, and wherein H(X), H(Y) and H(Z) are the values of constant at node X, Y and Z, respectively.

7. The method of claim 1, wherein the proximity value is a function of the bid intent and query intent.

8. The method of claim 1, wherein the effective bid value is a function of the click-through rate of an ad for the bid intent, the bid value for the item, and the proximity value for the item.

9. The method of claim 1, wherein the ranking of the items allows a search provider to send an item that is most likely to be appropriate to a user device associated with the query intent.

10. The method of claim 1, wherein intent of a particular user is not found when the particular user makes a query.

11. A system for sponsored search item bidding based on a user's query intent, the system comprising:
a computer system configured for:
receiving a bid intent of a messenger for an item, a query intent of a user, a click-through rate for the bid intent, and a bid value for the item, wherein the bid intent comprises the messenger's parameters for targeting the item, and wherein the query intent comprises an expression of what the user actually wants when the user initiates a search at a website;
generating a proximity value for the item by calculating a proximity between the bid intent of the messenger and the query intent of the user;
generating an effective bid value for the item by using the click-through rate for the bid intent, the bid value for the item, and the proximity value for the item; and
ranking the item among other items by using the effective bid value for the item, wherein the ranking is based on the query intent of the user.

12. The system of claim 11, wherein the computer system is further configured for generating an intent hierarchy including intent nodes and hierarchy levels for the intent nodes.

13. The system of claim 12, wherein each hierarchy level in the intent hierarchy is associated with a granularity level that includes at least one of:
very high level intent;
high level intent;
low level intent; and
very low level intent.

14. The system of claim 12, wherein the computer system is further configured for at least one of:
classifying the bid intent in the intent hierarchy; and
classifying the query intent in the intent hierarchy.

15. The system of claim 12, wherein the proximity value is calculated by using at least one of:
a first node in the intent hierarchy, wherein the first node represents the bid intent;
a second node in the intent hierarchy, wherein the second node represents the query intent; and
the lowest common ancestor of first node and the second node.

16. The system of claim 15, wherein the proximity value is denoted by the following equation:
$$P = \frac{H ( X ) + H ( Y )}{2 \times H ( Z )}$$
wherein X is the node in the intent hierarchy representing the query intent, and
wherein Y is the node in the intent hierarchy representing the bid intent, and
wherein Z be the lowest common ancestor of X and Y, and wherein H(X), H(Y) and H(Z) are the values of constant at node X, Y and Z, respectively.

17. The system of claim 11, wherein the proximity value is a function of the bid intent and query intent.

18. The system of claim 11, wherein the effective bid value is a function of the click-through rate for the bid intent, the bid value for the item, and the proximity value for the item.

19. The system of claim 11, wherein the ranking of the items allows a search provider to send an item that is most likely to be appropriate to a user device associated with the query intent.

20. The system of claim 11, wherein intent of a particular user is not found when the particular user makes a query.

21. A computer readable medium comprising one or more instructions for sponsored search item bidding based on a user's query intent, wherein the one or more instructions are configured for causing one or more processors to perform the steps of:
receiving, at a computer, a bid intent of a messenger for an item, a query intent of a user, a click-through rate for the bid intent, and a bid value for the item, wherein the bid intent comprises the messenger's parameters for targeting the item, and wherein the query intent comprises an expression of what the user actually wants when the user initiates a search at a website;
generating, at a computer, a proximity value for the item by calculating a proximity between the bid intent of the messenger and the query intent of the user;
generating, at a computer, an effective bid value for the item by using the click-through rate for the bid intent, the bid value for the item, and the proximity value for the item; and
ranking, at a computer, the item among other items by using the effective bid value for the item, wherein the ranking is based on the query intent of the user.
